(19) United States
(12) Patent Application Publication
(10) Pub. No.: US 2025/0058269 A1
(43) Pub. Date: Feb. 20, 2025

(54) PROCESSES FOR RECOVERING LPG FROM A REFORMING-ZONE EFFLUENT

(71) Applicant: UOP LLC, Des Plaines, IL (US)

(72) Inventors: Srinivasan Ramanujam, Haryana (IN); Eleftherios Adamopoulos, Gurnee, IL (US); William Yanez, Belvidere, IL (US); Harsh Satishbhai Patel, Gurjarat (IN)

(21) Appl. No.: 18/793,583

(22) Filed: Aug. 2, 2024

(30) Foreign Application Priority Data
Aug. 17, 2023 (IN) 202311055265

(51) Int. Cl. B01D 53/14; B01D 3/14; B01D 53/047; B01D 53/22; C01B 3/50; C01B 3/56; C10L 3/12

(52) U.S. Cl. CPC B01D 53/1437; B01D 3/145; B01D 53/047; B01D 53/1406; B01D 53/1418; B01D 53/1468; B01D 53/229; C01B 3/501; C01B 3/56; C10L 3/12; B01D 2256/16; B01D 2256/24; B01D 2257/304; B01D 2257/702; B01D 2257/80; C01B 2203/0405; C01B 2203/043; C01B 2203/048; C01B 2203/0485; C01B 2203/0495; C01B 2203/062; C10L 2290/30

(57) ABSTRACT

Apparatuses and methods for reforming of hydrocarbons including recovery of products. A reforming-zone effluent is separated into a net gas phase stream and a liquid phase hydrocarbon stream. The net gas phase stream may be passed separated into an H₂ rich stream and a tail gas stream in a PSA. The tail gas may be passed through an absorber and then passed through a membrane to form a second H₂ rich stream and a liquid stream. A second absorber is used to recover C₃/C₄ hydrocarbons. The two absorbers may be stacked on top of each other.

### CROSS-REFERENCES TO RELATED APPLICATIONS

This application claims priority to Indian Patent Application No. 202311055265 filed on Aug. 17, 2023, the entire disclosure of which is incorporated herein by way of reference.

### FIELD OF THE INVENTION

This invention relates generally to reforming hydrocarbons, and more particularly relates to apparatuses and methods for reforming of hydrocarbons with improved recovery of products from a reforming-zone effluent, specifically, LPG and hydrogen.

### BACKGROUND OF THE INVENTION

In catalytic reforming, a hydrocarbon feedstock of, for example, C₅ hydrocarbons to about C₁₁ hydrocarbons, is contacted with a reforming catalyst to convert at least a portion of the heavier hydrocarbons to aromatic hydrocarbons, for example, to increase the octane content of gasoline. The catalytic reforming of the heavier hydrocarbons to produce a reformate that includes aromatic hydrocarbons also produces significant quantities of valuable hydrogen and lighter hydrocarbons, such as liquefied petroleum gas (LPG) containing primarily C₃ and C₄ hydrocarbons. It has become desirable to maximize the recovery of hydrogen and LPG from the reforming reactor effluent, and to do so effectively and efficiently.

While presumable effective for their intended purposes, when hydrogen recovery units have a membrane separation unit, a significant amount of moisture and hydrogen sulfide (H₂S) are also recovered in the permeate stream due to their high polarity. This can lead to a build-up in the net gas section and upset the water-chloride balance. Additionally, in some cases it is undesirable to pass aromatics to a membrane separation unit.

Accordingly, it is desirable to provide apparatuses and methods for reforming of hydrocarbons with improved recovery of products from a reforming reactor effluent

### SUMMARY OF THE INVENTION

Apparatuses and methods for reforming of hydrocarbons including recovery of products are provided. As indicated above, while reforming reactions provide desirable chemical products, a byproduct of the reactions include C₃ and C₄ hydrocarbons, as well as hydrogen. The present processes and apparatuses provide effective and efficient recovery of hydrogen and C₃, C₄ and traces of C₅+ hydrocarbons from the reformate effluent.

Specifically, the present apparatuses and methods provide for the effective and efficient recovery of hydrogen and C₃, C₄ and traces of C₅+ hydrocarbons without a build up of water and hydrogen sulfide and by reducing the amount of aromatics passed to the membrane unit. These benefits may be achieved without requiring a sulfur guard bed and/or a drier and or any additional treating facilities. Additionally, the present apparatuses and methods permits the membrane unit size smaller by more than 40% and lower operating pressure of membrane by between 70-150 psig and thus the lower tail gas compressor power.

The present apparatuses and methods utilize two absorption zones which can preferably be combined in a single tower. The bottom absorber can have between twenty to thirty trays for tail gas absorption with a liquid. The top absorber may have between—ten to twenty trays for fractionation offgas absorption with a liquid. The pressure of each absorption zone is independent of each other.

The PSA tail gas and separator liquid is contacted in the tail gas absorber to recover the C₃+ material into the liquid. This also helps to absorb water and hydrogen sulfide into the liquid, so the absorber overhead vapor passed to the membrane is relatively free of moisture and hydrogen sulfide. Thus, a cooler, drier and sulfur guard beds are not required in the permeate stream.

Additionally, with a tail gas absorber, the concentration of benzene and toluene in the membrane feed is expected to be approx. 1000-5000 mol ppm. A cooler, chiller or a chilled water exchanger may be utilized to cool the stream and reduce the aromatic amounts, as well as traces of heavies, before the membrane separation.

Therefore, the present invention may be characterized, in at least one aspect, as providing a process for recovering hydrogen and hydrocarbons from a reformate effluent stream by: separating, in a first separation zone, a reforming-zone effluent comprising H₂, water, H₂S, C₄⁻ hydrocarbons, and C₅⁺ hydrocarbons, including aromatics, to form a net gas phase stream comprising C₄⁻ hydrocarbons and H₂ and a liquid phase hydrocarbon stream comprising C₅⁺ hydrocarbons including aromatics; separating, in a PSA separation zone, the net gas phase stream to form a first H₂ rich-stream and a tail gas stream that comprises H₂, water, H₂S, and C₆⁻ hydrocarbons; absorbing, in an absorption zone, hydrocarbons from the tail gas stream to form a hydrocarbon lean vapor stream and a hydrocarbon enriched liquid phase hydrocarbon stream, wherein a majority of the water and H₂S is present in the hydrocarbon enriched liquid phase hydrocarbon stream; separating hydrogen from the hydrocarbon lean vapor stream in a membrane separation zone to form a hydrogen rich recycle stream and a fuel gas stream; and, recycling the hydrogen rich recycle stream to the first separation zone.

The hydrogen rich recycle stream may be directly recycled from the membrane separation zone to the first separation zone.

The tail gas stream may be compressed before absorbing the hydrocarbons from the tail gas stream.

The tail gas stream may be cooled before the absorbing hydrocarbons from the tail gas stream.

The hydrocarbon lean vapor stream may be cooled before separating the hydrogen from the hydrocarbon lean vapor stream.

At least a portion of the liquid phase hydrocarbon stream comprising C₅+ hydrocarbons from the first separation zone may absorb hydrocarbons from the tail gas stream. The process may include cooling the portion of the liquid phase hydrocarbon stream comprising C₅⁺ hydrocarbons from the first separation zone that absorbs hydrocarbons from the tail gas stream.

The process may also include separating, in a fractionation zone, the hydrocarbon enriched liquid phase hydrocarbon stream into a reformate product stream, an LPG product stream, and an overhead stream.

The process may also include absorbing, in a second absorption zone, hydrocarbons from the overhead stream to form a second enriched liquid phase hydrocarbon stream and a second fuel gas stream, and, separating, in the fractionation zone, the second hydrocarbon enriched liquid phase hydrocarbon stream.

A portion of the liquid phase hydrocarbon stream comprising C₅⁺ hydrocarbons from the first separation zone may absorb hydrocarbons from the overhead stream in the second absorption zone. The process may include cooling the portion of the liquid phase hydrocarbon stream comprising C5+ hydrocarbons from the first separation zone that absorbs hydrocarbons from the overhead stream.

In at least one aspect the present invention may broadly be characterized as providing a process for recovering hydrogen and hydrocarbons from a reformate effluent stream by: separating, in a first separation zone, a reforming-zone effluent comprising H₂, C₄⁻ hydrocarbons, and C₅⁺ hydrocarbons, including aromatics, to form a net gas phase stream comprising C₆⁻ hydrocarbons and H₂ and a liquid phase hydrocarbon stream comprising C₅⁺ hydrocarbons including aromatics; separating, in a PSA separation zone, the net gas phase stream to form a first H₂ rich-stream and a tail gas stream that comprises H₂, and C₆⁻ hydrocarbons; absorbing, in an absorption zone, hydrocarbons from the tail gas stream to form a hydrocarbon lean vapor stream and a hydrocarbon enriched liquid phase hydrocarbon stream; separating hydrogen from the hydrocarbon lean vapor stream in a membrane separation zone to form a hydrogen rich recycle stream and a fuel gas stream; separating, in a fractionation zone, the hydrocarbon enriched liquid phase hydrocarbon stream into a reformate product stream, an LPG product stream, and an overhead stream; and, absorbing, in a second absorption zone, hydrocarbons from the overhead stream to form a second enriched liquid phase hydrocarbon stream and a second fuel gas stream.

The first absorption zone and the second absorption zone may be disposed one on top of the other.

The tail gas stream may be compressed before absorbing the hydrocarbons from the tail gas stream.

The tail gas stream may be cooled before absorbing the hydrocarbons from the tail gas stream.

The hydrocarbon lean vapor stream may be cooled, and traces of heavies may be removed from the vapor stream before separating the hydrogen from the hydrocarbon lean vapor stream.

The liquid phase hydrocarbon stream comprising C₅⁺ hydrocarbons from the first separation zone may absorb hydrocarbons from the tail gas stream.

A portion of the liquid phase hydrocarbon stream comprising C₅⁺ hydrocarbons from the first separation zone may absorb hydrocarbons from the overhead stream in the second absorption zone.

In one or more aspects, the present invention may generally be described as providing a process for recovering hydrogen and hydrocarbons from a reformate effluent stream by: separating, in a first separation zone, a reforming-zone effluent comprising H₂, C₄⁻ hydrocarbons, and C₅⁺ hydrocarbons, including aromatics, to form a net gas phase stream comprising C₆⁻ hydrocarbons and H₂ and a liquid phase hydrocarbon stream comprising C₅⁺ hydrocarbons including aromatics; separating, in a PSA separation zone, the net gas phase stream to form a first H₂ rich-stream and a tail gas stream that comprises H₂, and C₆⁻ hydrocarbons; absorbing, in an absorption zone, hydrocarbons from the tail gas stream to form a hydrocarbon lean vapor stream and a hydrocarbon enriched liquid phase hydrocarbon stream; separating hydrogen from the hydrocarbon lean vapor stream in a membrane separation zone to form a hydrogen rich recycle stream and a fuel gas stream; absorbing, in a second absorption zone, hydrocarbons from an overhead stream to form a second enriched liquid phase hydrocarbon stream and a second fuel gas stream, wherein the liquid phase hydrocarbon stream comprising C₅⁺ hydrocarbons from the first separation zone and the hydrocarbon enriched liquid phase hydrocarbon stream from the first absorption zone absorb hydrocarbons from the overhead stream in the second absorption zone; and, separating, in a fractionation zone, the second hydrocarbon enriched liquid phase hydrocarbon stream into a reformate product stream, an LPG product stream, and the overhead stream.

The first absorption zone and the second absorption zone may be disposed one on top of the other.

The liquid phase hydrocarbon stream comprising C₅⁺ hydrocarbons from the first separation zone may absorb hydrocarbons from the tail gas stream.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

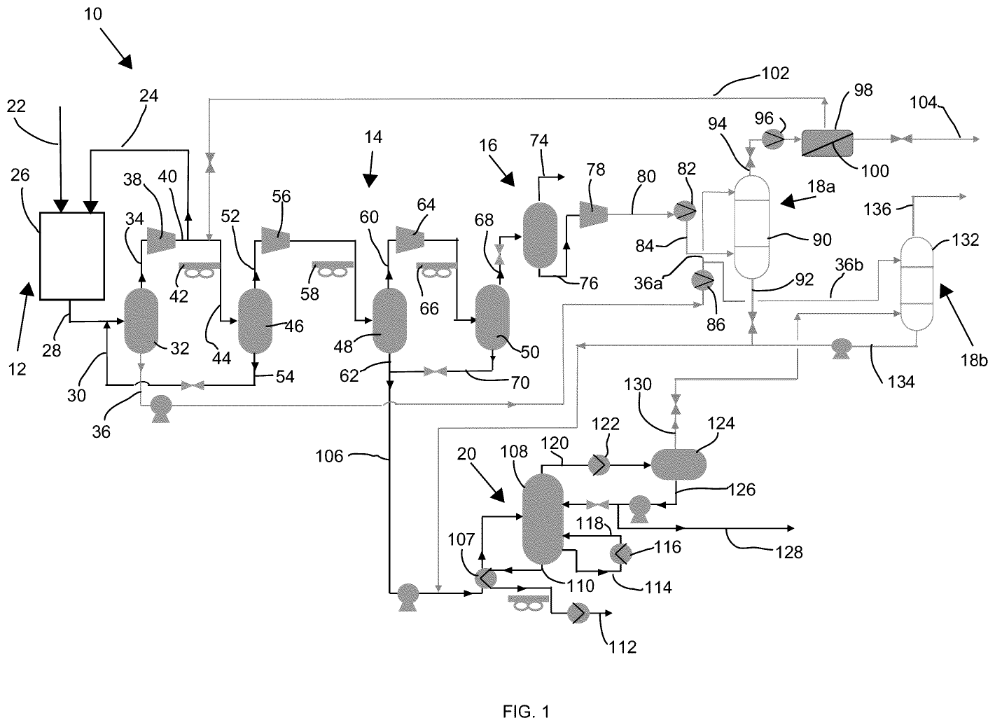

FIG. 1 schematically illustrates an apparatus and a method for reforming of hydrocarbons including recovery of products in accordance with an exemplary embodiment; and,

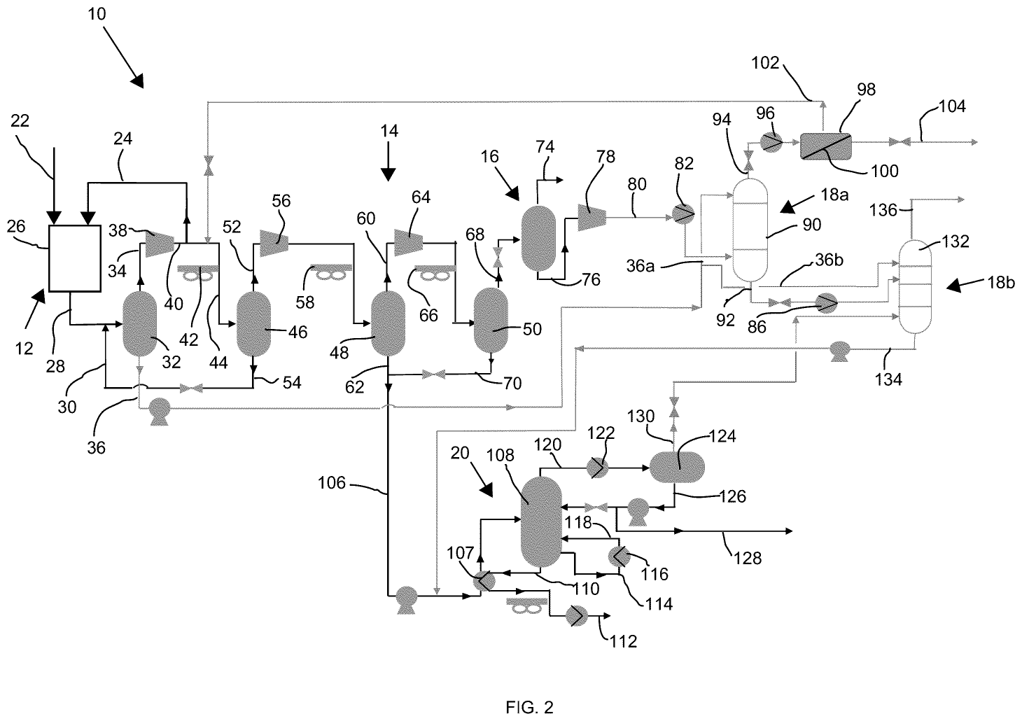

FIG. 2 schematically illustrates an apparatus and a method for reforming of hydrocarbons including recovery of products in accordance with another exemplary embodiment.

### DETAILED DESCRIPTION OF THE INVENTION

As mentioned above, the various embodiments contemplated herein relate to apparatuses and methods for the recovery of hydrocarbons products from a reforming effluent. The exemplary embodiments described herein provide a separation zone in fluid communication with a reforming zone to receive a reforming-zone effluent.

As used herein, the term “zone” refers to an area including one or more equipment items and/or one or more sub-zones. Equipment items can include one or more reactors or reactor vessels, scrubbers, strippers, fractionators or distillation columns, absorbers or absorber vessels, adsorber or adsorber vessels, regenerators, heaters, exchangers, coolers/chillers, pipes, pumps, compressors, controllers, membranes, and the like. Additionally, an equipment item can further include one or more zones or sub-zones.

The reforming-zone effluent comprises hydrogen (H₂), C₄ hydrocarbons, and C₅⁺ hydrocarbons including aromatics. As used herein, “Cₓ” means hydrocarbon molecules that have “X” number of carbon atoms, “Cₓ+” means hydrocarbon molecules that have “X” and/or more than “X” number of carbon atoms, and “Cₓ⁻” means hydrocarbon molecules that have “X” and/or less than “X” number of carbon atoms.

With these general principles in mind, one or more embodiments of the present invention will be described with the understanding that the following description is not intended to be limiting.

Referring to FIG. 1, an apparatus 10 according to various aspects for reforming of hydrocarbons in accordance with an exemplary embodiment is provided. The apparatus 10 may include a reforming zone 12, a first separation zone 14, a PSA separation zone 16, a first absorption zone 18a, a fractionation zone 20, and a second absorption zone 18b.

In exemplary embodiment, a reforming feedstock 22 containing naphtha fraction hydrocarbons, such as from C₅ to about C₁₁ hydrocarbons with a boiling point range of, for example, from about 70 to about 205° C. (158 and 401° F.), is passed to the reforming zone 12. In the reforming zone 12, the reforming feedstock 22 and a recycle gas phase stream 24 (discussed in further detail below) are received by a reactor 26 that contains a reforming catalyst as is well-known in the art. The reforming zone 12 may include a plurality of stacked or side-by-side reactors 26 with provisions for intermediate heating of the intermediate reactant stream (e.g., the reforming feedstock 22 and the recycle gas phase stream 24 including any conversion products formed therefrom) and one or more heat exchangers. In an exemplary embodiment, the recycle gas phase stream 24 is combined with the reforming feedstock 22 for contact with the reforming catalyst.

A reforming-zone effluent 28 from the reforming zone 12 and contains H₂, water, H₂S, C₅⁺ hydrocarbons including aromatics, and lighter hydrocarbons such as C₄⁻ hydrocarbons including C₃ and C₄ hydrocarbons. In an exemplary embodiment, the reforming-zone effluent 28 is a two-phase liquid-gas stream in which H₂ and the lighter hydrocarbons (e.g., C₄⁻ hydrocarbons) are predominantly in the gas phase and the heavier hydrocarbons (e.g., C₅⁺ hydrocarbons including aromatics) are predominantly in the liquid phase. In one embodiment, the reforming-zone effluent 28 has a temperature of from about 35 to about 50° C. and, independently, a pressure of from about 240 to about 830 kPa gauge (34.8 and 120 psig).

The reforming-zone effluent 28, along with a recycle liquid stream 30, is introduced to a separation vessel 32 in the first separation zone 14. In the vessel 32 of the first separation zone 14, the reforming-zone effluent 28 is separated into a gas phase stream 34 and a liquid phase hydrocarbon stream 36. In an exemplary embodiment, the gas phase stream 34 comprises H₂, C₆⁻ hydrocarbons, and impurities such as carbon monoxide and/or nitrogen, and the liquid phase hydrocarbon stream 36 comprises C₅⁺ hydrocarbons including aromatics. In one example, the gas phase stream 34 comprises H₂ present in an amount of from about 80 to about 90 mole %, C₁ hydrocarbons present in an amount of about 2 to about 5 mole %, C₂ hydrocarbons present in an amount of from about 2 to about 5 mole %, C₃ hydrocarbons present in an amount of from about 2 to about 4 mole %, C₄ hydrocarbons present in an amount of from about 1.5 to about 2.5 mole %, and possibly some C₅⁺ hydrocarbons. In another example, the liquid phase hydrocarbon stream 36 comprises C₅⁺ hydrocarbons present in an amount of from about 90 to about 99.9 mole % and possibly some C₄ hydrocarbons and H₂. In an exemplary embodiment, the separation zone 14 is operated at a temperature of from about 35 to about 50° C. (95 to 122° F.). and, independently, a pressure of from about 70 to about 830 kPa gauge (10 to 120 psig).

The gas phase stream 34 is passed to a compressor 38 to form a compressed gas phase stream 40. A portion of the compressed gas phase stream 40 may be used as the recycle gas phase stream 24 mentioned above. The remaining portion of the compressed gas phase stream 40 is passed to a cooler 42. In the cooler 42, the compressed gas phase stream 40 is partially cooled to form a partially cooled, compressed gas phase stream 44. In an exemplary embodiment, the partially cooled, compressed gas phase stream 44 has a temperature of from about 30 to about 65° C. (86 to 149° F.) and, independently, a pressure of from about 410 to about 2,460 kPa gauge (60 to 356.8 psig).

The partially cooled, compressed gas phase stream 44 may be passed to a vessel 46, which may be a suction drum. In the vessel 46, the partially cooled, compressed gas phase stream 44 is separated into a first stage vapor stream 52 and a first stage liquid stream 54. The first stage liquid stream 54 may be used as the recycle stream 30 mentioned above or directly pumped to the fractionation zone 20. The first stage vapor stream 52 is compressed in a compressor 56, cooled in a cooler 58 and passed to a second vessel 48. In the second vessel 48, the first stage vapor stream 52 is separated into a second stage vapor stream 60 and a second stage liquid stream 62. The second stage vapor stream 60 is compressed in another compressor 64, cooled in another cooler 66 and passed to a third vessel 50. In the third vessel 50, the second stage vapor stream 60 is separated into a third stage vapor stream 68, or a net gas phase stream comprising C₆⁻ hydrocarbons and H₂, and a third stage liquid stream 70. The third stage liquid stream 70 may be combined with the second stage liquid stream 62, both comprising C5+ hydrocarbons and passed to the fractionation zone 20 (discussed in more detail below). Any number of separation vessels and stages of compression may be used, and the depicted arrangement is merely exemplary.

A temperature of the third stage vapor stream 68 is between approximately 15.6 and 71.1° C. (60 and 160° F.) and a pressure of the third stage vapor stream 68 is between approximately 1,724 and 4,826 kPa gauge (250 to 700 psig). The third stage vapor stream 68 may be passed to the PSA zone 16 for separating the third stage vapor stream 68 into a first H₂ rich-stream 74 and a tail gas stream 76 that comprises H₂, water, H₂S, and C₆⁻ hydrocarbons.

In an exemplary embodiment, the PSA separation zone 16 contains an adsorbent (e.g., adsorbent material(s)) and is configured for contacting the third stage vapor stream 68 with the adsorbent for selectively separating H₂ from hydrocarbons (e.g., C₄⁻ hydrocarbons) and impurities such as carbon monoxide and/or nitrogen to form the first H₂ rich-stream 74. The PSA separation zone 16 operates on the principle of selectively adsorbing hydrocarbons and/or other impurities (e.g., carbon monoxide and/or nitrogen) onto the adsorbent at a relatively high pressure (e.g., about 1,920 to about 5,520 kPa gauge (280 to 800 psig) to form the first H₂ rich-stream 74, and desorbing the hydrocarbons from the adsorbent at relatively low pressure (e.g., about 10 to about 500 kPa gauge (1.45 to 72.5 psig)) to regenerate the adsorbent and to form a tail gas stream 76 that contains the hydrocarbons and/or other impurities (e.g., carbon monoxide and/or nitrogen).

In an exemplary embodiment, the PSA separation zone 16 includes a plurality of fixed-bed adsorption units each containing layers of different adsorbent materials where the lower layer or layers are filled with weaker adsorbent materials, e.g., relatively low affinity for adsorbing gaseous hydrocarbons, and the upper layer or layers are filled with stronger adsorbent materials, e.g., relatively high affinity for adsorbing gaseous hydrocarbons (e.g., gaseous C₃⁻ hydrocarbons) and impurities (e.g., carbon monoxide and/or nitrogen). For example, the lower layer(s) can contain weakly adsorbent materials, such as activated alumina and/or silica gel, while the intermediate layer(s) can contain intermediate strength adsorbent materials, such as activated carbon, and the upper layer(s) can contain strong adsorbent materials, such as zeolite and/or molecular sieve materials. In an exemplary embodiment, the multiple fixed-bed adsorption units cooperatively operate in a staggered sequence to produce constant feed (e.g., stream 68), product (e.g., stream 74), and tail gas (e.g., stream 76) flows. In an exemplary embodiment, the PSA separation zone 16 operates following a five-step pressure-swing cycle including an adsorption step, a co-current depressurization step, a counter-current depressurization step, a purge step, and a repressurization step. During the adsorption step, the third stage vapor stream 68 enters a lower portion of the fixed-bed adsorption unit at a relatively high pressure, and as the feed gas rises in the unit, the hydrocarbons and impurities (e.g., carbon monoxide and/or nitrogen) are adsorbed in the various layers of the adsorbent materials depending upon their respective adsorption selectivity to form the first H₂ rich-stream 74. The co-current depressurization, counter-current depressurization and purge steps decrease the pressure in the fixed-bed adsorption unit and purge the unit with high purity gas from the product (e.g., first H₂ rich-stream 74) or co-current depressurization steps, respectively, to remove the hydrocarbons and impurities (e.g., carbon monoxide and/or nitrogen) and regenerate the adsorption materials. The repressurization step increases the pressure in the fixed-bed adsorption unit with either feed gas (e.g., stream 68) or product gas (e.g., the first H₂ rich-stream 74) in preparation for the next adsorption step. Other pressure swing adsorption configurations for recovering hydrogen in the PSA separation zone 16 known to those skilled in the art may also be used.

In an exemplary embodiment, first H₂ rich-stream 74 comprises H₂ present in an amount of from about 90 to less than 100 mole %, such as from about 90 to about 99.999 mole %, such as from about 95 to about 99.999 mole %, such as from about 98 to about 99.999 mole %, such as from about 99 to about 99.999 mole %, for example about 99.99 mole %, and possibly some C₂− hydrocarbons and impurities (e.g., carbon monoxide and/or nitrogen). In an exemplary embodiment, the tail gas stream 76 comprises C₂− hydrocarbons present in an amount of from about 25 to about 80 mole %, H₂ present in an amount of from about 25 to about 75 mole %, and some C₃⁺ hydrocarbons and impurities (e.g., water, hydrogen sulfide, carbon monoxide and/or nitrogen).

The first H₂ rich-stream 74 is removed from the apparatus 10, for example, to be used as a hydrogen product stream. The tail gas stream 76 is passed through a compressor 78 to form a compressed tail gas stream 80 that is further advanced through a cooler 82 to partially cool the compressed tail gas stream 80 and form a partially cooled, compressed PSA tail gas stream 84. The compressed tail gas stream 80 may be cooled to a temperature between 15.6 and 71.1° C. (60 and 160° F.). The partially cooled, compressed PSA tail gas stream 84 is passed to the first absorption zone 18a.

The absorption zone 18a also receives a portion 36a of the liquid phase hydrocarbon stream 36 from the first separation zone 14. As shown in FIG. 1, the liquid phase hydrocarbon stream 36 is cooled in a cooler 86 and then the first portion 36a is introduced into the absorption zone 18a.

In an exemplary embodiment, the partially cooled, compressed PSA tail gas stream 84 is introduced to a lower portion of an absorber vessel 90 having, for example twenty to thirty trays, and rises upwardly while the first portion 36a of the liquid phase hydrocarbon stream 36 is introduced to an upper portion of the absorber vessel 90 and descends downwardly for countercurrent contact with the partially cooled, compressed PSA tail gas stream 84. During contact in the absorber vessel 90, C₃/C₄ hydrocarbons from the partially cooled, compressed PSA tail gas stream 84 are extracted and/or absorbed to the first portion 36a of the liquid phase hydrocarbon stream 36 to form a hydrocarbon enriched liquid phase hydrocarbon stream 92. In addition to C₃/C₄ hydrocarbons, the hydrocarbon enriched liquid phase hydrocarbon stream 92 may include C₅⁺ hydrocarbons, as well as, most of or all of, the water and hydrogen sulfide from the tail gas stream 76.

A hydrocarbon lean vapor stream 94 which comprises H₂, as well as C₂ hydrocarbons is also recovered from the absorber vessel 90. The hydrocarbon lean vapor stream 94 is cooled in an exchanger 96 or other device to remove traves of heavy components and then passed to a membrane separation zone 98. Although not depicted, a slip stream of an external liquid of C₅-C₆ stream or a stream within the same complex as the reformate splitter column liquid or a raffinate stream from a downstream aromatics complex can be utilized to improve the absorption of C₇+ heavies in the lean vapor in the absorber 18a as an additional trayed section above the portion 36a with maximum 10 trays. Alternatively it is contemplated to contact the hydrocarbon lean vapor stream 94 with the external liquid stream of C₅-C₆ stream or a stream within the same complex as the reformate splitter liquid or a raffinate stream from a downstream aromatics complex and cool them to improve the C₇+ heavies recovery and separate them in a vapor liquid separator to recover the C₇+ heavies from the lean vapor.

The membrane separation zone 98 includes an H₂/hydrocarbon separation membrane 100 that is selectively permeable to H₂ while being effectively non-permeable to hydrocarbons, e.g., C₄⁻ hydrocarbons and impurities (e.g., carbon monoxide and/or nitrogen). In commercially available embodiments, the H₂/hydrocarbon separation membrane 100 may be in the form of either spiral wound or hollow fibers, made of cellulose acetate, cellulose triacetate, polyimide, polysulfone material or any other suitable material. Such fibers may be assembled into compact bundles to provide a large membrane area available for the passage of the desired product gas (H₂) therethrough. Alternatively, the H₂/hydrocarbon separation membrane 100 can be any other separation membrane known to those skilled in the art for separating H₂, hydrocarbons, and impurities (e.g., carbon monoxide and/or nitrogen). In an exemplary embodiment, the H₂/hydrocarbon separation membrane 100 has a selectivity of at least about 60, preferably at least about 75, for example from about 75 to about 370 or greater, of H₂ over C₄⁻ hydrocarbons, and other impurities such as CO, N₂ and the like.

A second H₂ rich-stream 102 is provided by the membrane separation zone 98 as a permeate, while a retentate from the membrane separation zone 102 comprises a fuel gas stream 104. The fuel gas stream 104 may be cooled before being sent to fuel gas header. The second H₂ rich-stream 102 includes between 85-95 mole % of hydrogen and the remaining 5-15 mole % of C₄−. This stream is relatively free from water and hydrogen sulfide and may contain less than 10-20 mol ppm of water and less than 5 mol ppm of H₂S may be recycled to the first separation zone 14, for example by being combined with the compressed gas phase stream 40.

In order to recover the reformate products and LPG, as mentioned above, the third stage liquid stream 70 and the second stage liquid stream 62 from the first separation zone 14 (hereinafter the combined liquid phase stream 106), are passed to the fractionation zone 20.

After being heated in a heat exchanger 107, the combined liquid phase stream 106, is passed to a separation column 108, for example a debutanizer column or a depentanizer column. A bottoms stream 110 from the separation column 108 may be sent to the heat exchanger 107, cooled, and exchanged with other streams to receive heat and provide a reformate product stream 112. A reboiling portion 114 may be heated with steam or hot oil in a heat exchanger 116 to provide a reboiled portion 118, which may supply heat to the separation column 108 for separating the components therein. An overhead stream 120 may be cooled in a heat exchanger 122 and passed to a receiver 124. A receiver bottoms 126 may be recovered from the receiver 124, with a portion being refluxed back to the separation column 108 and a second portion forming an LPG product stream 128.

A receiver overhead stream 130 may be passed to the second absorption zone 18b. The second absorption zone 18b receives a second portion 36b of the liquid phase hydrocarbon stream 36 from the first separation zone 14.

In an exemplary embodiment, the receiver overhead stream 130 is introduced to a lower portion of an absorber vessel 132, having for example, ten to twenty trays, in the second absorption zone 18b and rises upwardly while the second portion 36b of the liquid phase hydrocarbon stream 36 is introduced to an upper portion of the absorber vessel 132 and descends downwardly for countercurrent contact with the receiver overhead. During contact in the absorber vessel 132, C₃/C₄ hydrocarbons are extracted and/or absorbed to the second portion 36b of the liquid phase hydrocarbon stream 36 to form a second hydrocarbon enriched liquid phase hydrocarbon stream 134. An overhead stream 136 from the second absorption zone 18b may be a second fuel gas stream 136. The overhead stream 136 may be chloride treated before sent to fuel gas header.

The first and second hydrocarbon enrich liquid streams 92, 134 may be passed to the fractionation zone 20, for example, by being combined with each other and with the combined liquid phase stream 106.

Turning to FIG. 2, a second embodiment is shown, in which, identical reference numerals are used with identical elements, and the above description is hereby incorporated by referenced.

In FIG. 2, the first hydrocarbon enriched liquid phase stream 92 is passed to the second absorption zone 18a. Preferably, the first hydrocarbon enriched liquid phase stream 92 is cooled and introduced into the vessel 132 between the second portion 36b of the liquid phase hydrocarbon stream 36 and the receiver overhead stream 130. Additionally, in this embodiment, only the second portion 36b of the liquid phase hydrocarbon stream 36 is cooled. The second hydrocarbon enriched liquid phase hydrocarbon stream 134, which is a combined stream, is passed to the fractionization zone 20. Although not depicted, instead of the first hydrocarbon enriched liquid phase stream 92 being used in the second absorption zone 18b, a slip stream of the reformate product stream 112 or an external liquid of C₈+ stream within the same complex can be utilized.

The embodiment of FIG. 1 is contemplated to be most effective when the separation column 108 is a depentanizer column, while the embodiment of FIG. 2 is contemplated to be most effective when the separation column 108 is a debutanizer column.

The ratio of the first portion 36a to the second portion 36b of the liquid phase hydrocarbon stream 36 will depend on whether the separation column 108 is a depentanizer column or a debutanizer column. When the separation column 108 is a depentanizer column, preferably in the embodiment of FIG. 1, the ratio can be 80/20 (i.e., 80% as the first portion 36a and 20% as the second portion). When the separation column 108 is a debutanizer column, preferably in the embodiment of FIG. 2, the ratio can be 60/40 (i.e., 60% as the first portion 36a and 40% as the second portion).

Finally, in both embodiments, it is contemplated that the two absorption zones 18a, 18b are in the same tower, with one on top of the other. Such a configuration would, in addition to the foregoing benefits, save plot space.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

### SPECIFIC EMBODIMENTS

While the following is described in conjunction with specific embodiments, it will be understood that this description is intended to illustrate and not limit the scope of the preceding description and the appended claims.

A first embodiment of the invention is a process for recovering hydrogen and hydrocarbons from a reformate effluent stream, the process comprising separating, in a first separation zone, a reforming-zone effluent comprising H₂, water, H₂S, C₄⁻ hydrocarbons, and C₅⁺ hydrocarbons, including aromatics, to form a net gas phase stream comprising C₆⁻ hydrocarbons and H₂ and a liquid phase hydrocarbon stream comprising C₅⁺ hydrocarbons including aromatics; separating, in a PSA separation zone, the net gas phase stream to form a first H₂ rich-stream and a tail gas stream that comprises H₂, water, H₂S, and C₆⁻ hydrocarbons; absorbing, in an absorption zone, hydrocarbons from the tail gas stream to form a hydrocarbon lean vapor stream and a hydrocarbon enriched liquid phase hydrocarbon stream, wherein a majority of the water and H₂S is present in the hydrocarbon enriched liquid phase hydrocarbon stream; separating hydrogen from the hydrocarbon lean vapor stream in a membrane separation zone to form a hydrogen rich recycle stream and a fuel gas stream; and, recycling the hydrogen rich recycle stream to the first separation zone. An embodiment of the invention is one, any or all of prior embodiments in this paragraph up through the first embodiment in this paragraph further comprising wherein the hydrogen rich recycle stream is directly recycled from the membrane separation zone to the first separation zone. An embodiment of the invention is one, any or all of prior embodiments in this paragraph up through the first embodiment in this paragraph wherein the tail gas stream is compressed before the absorbing hydrocarbons from the tail gas stream. An embodiment of the invention is one, any or all of prior embodiments in this paragraph up through the first embodiment in this paragraph wherein the tail gas stream is cooled before the absorbing hydrocarbons from the tail gas stream. An embodiment of the invention is one, any or all of prior embodiments in this paragraph up through the first embodiment in this paragraph, wherein the hydrocarbon lean vapor stream is cooled before the separating hydrogen from the hydrocarbon lean vapor stream. An embodiment of the invention is one, any or all of prior embodiments in this paragraph up through the first embodiment in this paragraph, wherein the at least a portion of the liquid phase hydrocarbon stream comprising C₅⁺ hydrocarbons from the first separation zone absorbs hydrocarbons from the tail gas stream. An embodiment of the invention is one, any or all of prior embodiments in this paragraph up through the first embodiment in this paragraph further comprising cooling the portion of the liquid phase hydrocarbon stream comprising C₅⁺ hydrocarbons from the first separation zone that absorbs hydrocarbons from the tail gas stream. An embodiment of the invention is one, any or all of prior embodiments in this paragraph up through the first embodiment in this paragraph further comprising separating, in a fractionation zone, the hydrocarbon enriched liquid phase hydrocarbon stream into a reformate product stream, an LPG product stream, and an overhead stream. An embodiment of the invention is one, any or all of prior embodiments in this paragraph up through the first embodiment in this paragraph further comprising absorbing, in a second absorption zone, hydrocarbons from the overhead stream to form a second enriched liquid phase hydrocarbon stream and a second fuel gas stream; and, separating, in the fractionation zone, the second hydrocarbon enriched liquid phase hydrocarbon stream. An embodiment of the invention is one, any or all of prior embodiments in this paragraph up through the first embodiment in this paragraph, wherein a portion of the liquid phase hydrocarbon stream comprising C₅⁺ hydrocarbons from the first separation zone absorbs hydrocarbons from the overhead stream in the second absorption zone.

A second embodiment of the invention is a process for recovering hydrogen and hydrocarbons from a reformate effluent stream, the process comprising separating, in a first separation zone, a reforming-zone effluent comprising H₂, C₄⁻ hydrocarbons, and C₅⁺ hydrocarbons, including aromatics, to form a net gas phase stream comprising C₆⁻ hydrocarbons and H₂ and a liquid phase hydrocarbon stream comprising C₅⁺ hydrocarbons including aromatics; separating, in a PSA separation zone, the net gas phase stream to form a first H₂ rich-stream and a tail gas stream that comprises H₂, and C₆⁻ hydrocarbons; absorbing, in an absorption zone, hydrocarbons from the tail gas stream to form a hydrocarbon lean vapor stream and a hydrocarbon enriched liquid phase hydrocarbon stream; separating hydrogen from the hydrocarbon lean vapor stream in a membrane separation zone to form a hydrogen rich recycle stream and a fuel gas stream; separating, in a fractionation zone, the hydrocarbon enriched liquid phase hydrocarbon stream into a reformate product stream, an LPG product stream, and an overhead stream; and, absorbing, in a second absorption zone, hydrocarbons from the overhead stream to form a second enriched liquid phase hydrocarbon stream and a second fuel gas stream. An embodiment of the invention is one, any or all of prior embodiments in this paragraph up through the second embodiment in this paragraph, wherein the first absorption zone and the second absorption zone are disposed one on top of the other. An embodiment of the invention is one, any or all of prior embodiments in this paragraph up through the second embodiment in this paragraph, wherein the tail gas stream is compressed before the absorbing hydrocarbons from the tail gas stream. An embodiment of the invention is one, any or all of prior embodiments in this paragraph up through the second embodiment in this paragraph, wherein the tail gas stream is cooled before the absorbing hydrocarbons from the tail gas stream. An embodiment of the invention is one, any or all of prior embodiments in this paragraph up through the second embodiment in this paragraph, wherein the hydrocarbon lean vapor stream is cooled and traces of heavies are removed from the vapor stream before the separating hydrogen from the hydrocarbon lean vapor stream. An embodiment of the invention is one, any or all of prior embodiments in this paragraph up through the second embodiment in this paragraph, wherein the liquid phase hydrocarbon stream comprising C₅⁺ hydrocarbons from the first separation zone absorbs hydrocarbons from the tail gas stream. An embodiment of the invention is one, any or all of prior embodiments in this paragraph up through the second embodiment in this paragraph, wherein a portion of the liquid phase hydrocarbon stream comprising C₅⁺ hydrocarbons from the first separation zone absorbs hydrocarbons from the overhead stream in the second absorption zone.

A third embodiment of the invention is a process for recovering hydrogen and hydrocarbons from a reformate effluent stream, the process comprising separating, in a first separation zone, a reforming-zone effluent comprising H₂, C₄⁻ hydrocarbons, and C₅⁺ hydrocarbons, including aromatics, to form a net gas phase stream comprising C₆⁻ hydrocarbons and H₂ and a liquid phase hydrocarbon stream comprising C₅⁺ hydrocarbons including aromatics; separating, in a PSA separation zone, the net gas phase stream to form a first H₂ rich-stream and a tail gas stream that comprises H₂, and C₆⁻ hydrocarbons; absorbing, in an absorption zone, hydrocarbons from the tail gas stream to form a hydrocarbon lean vapor stream and a hydrocarbon enriched liquid phase hydrocarbon stream; separating hydrogen from the hydrocarbon lean vapor stream in a membrane separation zone to form a hydrogen rich recycle stream and a fuel gas stream; absorbing, in a second absorption zone, hydrocarbons from an overhead stream to form a second enriched liquid phase hydrocarbon stream and a second fuel gas stream, wherein the liquid phase hydrocarbon stream comprising C₅⁺ hydrocarbons from the first separation zone and the hydrocarbon enriched liquid phase hydrocarbon stream from the first absorption zone absorb hydrocarbons from the overhead stream in the second absorption zone; and, separating, in a fractionation zone, the second hydrocarbon enriched liquid phase hydrocarbon stream into a reformate product stream, an LPG product stream, and the overhead stream. An embodiment of the invention is one, any or all of prior embodiments in this paragraph up through the third embodiment in this paragraph, wherein the first absorption zone and the second absorption zone are disposed one on top of the other. An embodiment of the invention is one, any or all of prior embodiments in this paragraph up through the third embodiment in this paragraph, wherein the liquid phase hydrocarbon stream comprising C₅⁺ hydrocarbons from the first separation zone absorbs hydrocarbons from the tail gas stream.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for recovering hydrogen and hydrocarbons from a reformate effluent stream, the process comprising:
separating, in a first separation zone, a reforming-zone effluent comprising H₂, traces of water, H₂S, C₄⁻ hydrocarbons, and C₅⁺ hydrocarbons, including aromatics, to form a net gas phase stream comprising C₆⁻ hydrocarbons and H₂ and a liquid phase hydrocarbon stream comprising C₅⁺ hydrocarbons including aromatics;
separating, in a PSA separation zone, the net gas phase stream to form a first H₂ rich-stream and a tail gas stream that comprises H₂, water, H₂S, and C₆⁻ hydrocarbons;
absorbing, in an absorption zone, hydrocarbons from the tail gas stream to form a hydrocarbon lean vapor stream and a hydrocarbon enriched liquid phase hydrocarbon stream, wherein a majority of the water and H₂S is present in the hydrocarbon enriched liquid phase hydrocarbon stream;
separating hydrogen from the hydrocarbon lean vapor stream in a membrane separation zone to form a hydrogen rich recycle stream and a fuel gas stream; and,
recycling the hydrogen rich recycle stream to the first separation zone.

2. The process of claim 1 further comprising:
wherein the hydrogen rich recycle stream is directly recycled from the membrane separation zone to the first separation zone.

3. The process of claim 1 wherein the tail gas stream is compressed before the absorbing hydrocarbons from the tail gas stream.

4. The process of claim 1 wherein the tail gas stream is cooled before the absorbing hydrocarbons from the tail gas stream.

5. The process of claim 1, wherein the hydrocarbon lean vapor stream is cooled before the separating hydrogen from the hydrocarbon lean vapor stream.

6. The process of claim 1, wherein the at least a portion of the liquid phase hydrocarbon stream comprising C₅⁺ hydrocarbons from the first separation zone absorbs hydrocarbons from the tail gas stream.

7. The process of claim 6 further comprising:
cooling the portion of the liquid phase hydrocarbon stream comprising C₅⁺ hydrocarbons from the first separation zone that absorbs hydrocarbons from the tail gas stream.

8. The process of claim 1 further comprising:
separating, in a fractionation zone, the hydrocarbon enriched liquid phase hydrocarbon stream into a reformate product stream, an LPG product stream, and an overhead stream.

9. The process of claim 8 further comprising:
absorbing, in a second absorption zone, hydrocarbons from the overhead stream to form a second enriched liquid phase hydrocarbon stream and a second fuel gas stream; and,
separating, in the fractionation zone, the second hydrocarbon enriched liquid phase hydrocarbon stream.

10. The process of claim 9, wherein a portion of the liquid phase hydrocarbon stream comprising C₅⁺ hydrocarbons from the first separation zone is cooled and then absorbs hydrocarbons from the overhead stream in the second absorption zone.

11. A process for recovering hydrogen and hydrocarbons from a reformate effluent stream, the process comprising:
separating, in a first separation zone, a reforming-zone effluent comprising H₂, C₄⁻ hydrocarbons, and C₅⁺ hydrocarbons, including aromatics, to form a net gas phase stream comprising C₆⁻ hydrocarbons and H₂ and a liquid phase hydrocarbon stream comprising C₅⁺ hydrocarbons including aromatics;
separating, in a PSA separation zone, the net gas phase stream to form a first H₂ rich-stream and a tail gas stream that comprises H₂, and C₆⁻ hydrocarbons;
absorbing, in a first absorption zone, hydrocarbons from the tail gas stream to form a hydrocarbon lean vapor stream and a hydrocarbon enriched liquid phase hydrocarbon stream;
separating hydrogen from the hydrocarbon lean vapor stream in a membrane separation zone to form a hydrogen rich recycle stream and a fuel gas stream;
separating, in a fractionation zone, the hydrocarbon enriched liquid phase hydrocarbon stream into a reformate product stream, an LPG product stream, and an overhead stream; and,
absorbing, in a second absorption zone, hydrocarbons from the overhead stream to form a second enriched liquid phase hydrocarbon stream and a second fuel gas stream.

12. The process of claim 11, wherein the first absorption zone and the second absorption zone are disposed one on top of the other.

13. The process of claim 11, wherein the tail gas stream is compressed before the absorbing hydrocarbons from the tail gas stream.

14. The process of claim 11, wherein the tail gas stream is cooled before the absorbing hydrocarbons from the tail gas stream.

15. The process of claim 11, wherein the hydrocarbon lean vapor stream is cooled and traces of heavies are removed before the separating hydrogen from the hydrocarbon lean vapor stream.

16. The process of claim 11, wherein the liquid phase hydrocarbon stream comprising C₅⁺ hydrocarbons from the first separation zone absorbs hydrocarbons from the tail gas stream.

17. The process of claim 11, wherein a portion of the liquid phase hydrocarbon stream comprising C₅⁺ hydrocarbons from the first separation zone absorbs hydrocarbons from the overhead stream in the second absorption zone.

18. A process for recovering hydrogen and hydrocarbons from a reformate effluent stream, the process comprising:
separating, in a first separation zone, a reforming-zone effluent comprising H₂, C₄⁻ hydrocarbons, and C₅⁺ hydrocarbons, including aromatics, to form a net gas phase stream comprising C₆⁻ hydrocarbons and H₂ and a liquid phase hydrocarbon stream comprising C₅⁺ hydrocarbons including aromatics;
separating, in a PSA separation zone, the net gas phase stream to form a first H₂ rich-stream and a tail gas stream that comprises H₂, and C₆⁻ hydrocarbons;
absorbing, in a first absorption zone, hydrocarbons from the tail gas stream to form a hydrocarbon lean vapor stream and a hydrocarbon enriched liquid phase hydrocarbon stream;
separating hydrogen from the hydrocarbon lean vapor stream in a membrane separation zone to form a hydrogen rich recycle stream and a fuel gas stream;
absorbing, in a second absorption zone, hydrocarbons from an overhead stream to form a second enriched liquid phase hydrocarbon stream and a second fuel gas stream, wherein the liquid phase hydrocarbon stream comprising C₅⁺ hydrocarbons from the first separation zone and the hydrocarbon enriched liquid phase hydrocarbon stream from the first absorption zone absorb hydrocarbons from the overhead stream in the second absorption zone; and,
separating, in a fractionation zone, the second hydrocarbon enriched liquid phase hydrocarbon stream into a reformate product stream, an LPG product stream, and the overhead stream.

19. The process of claim 18, wherein the first absorption zone and the second absorption zone are disposed one on top of the other.

20. The process of claim 18, wherein the liquid phase hydrocarbon stream comprising C₅⁺ hydrocarbons from the first separation zone and the hydrocarbon enriched liquid phase hydrocarbon stream from the first absorption zone absorbs hydrocarbons from the tail gas stream.
